(19) United States
(12) Patent Application Publication
(10) Pub. No.: US 2005/0168127 A1
(43) Pub. Date: Aug. 4, 2005

(54) [WHITE LIGHT LED]

(76) Inventors: Shih-Chang Shei, Tainan (TW); Jinn-Kong Sheu, Tainan County (TW); Jui-Kung Wu, Kaohsiung County (TW); Tai-Yu Chen, Kaohsiung County (TW); Chao-Lung Huang, Kaohsiung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,002

(22) Filed: Aug. 17, 2004

(30) Foreign Application Priority Data
Jan. 30, 2004 (TW) 93102094

(51) Int. Cl. H05B 33/00

(52) U.S. Cl. 313/487; 313/486; 313/512

(57) ABSTRACT

A white light LED is provided. The white light LED includes an exciting light source and a fluorescent powder, wherein the wavelength of the light emitting from the exciting light source is in a range of about 250 nm to about 490 nmt. The fluorescent powder is disposed around the exciting light source to receive the light emitting from the exciting light source. Furthermore, the material of the fluorescent powder includes (Tb_{3-x-y}CeₓRe_{y})Al₅O₁₂, (Me_{1-x-y}EuₓRe_{y})₃SiO₅, YBO₃:Ce³⁺, YBO₃:Tb³⁺, SrGa₂O₄:Eu²⁺, SrAl₂O₄:Eu²⁺, (Ba,Sr)MgAl₁₀:Eu²⁺, Mn²⁺, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd³⁺. The white light LED of the invention provides high luminous efficiency and excellent color rendering index.

### CROSS REFERENCE TO RELATED APPLICATIONS

This application claims the priority benefit of Taiwan application serial no. 93102094, filed Jan. 30, 2004.

### BACKGROUND OF INVENTION

1. Field of the Invention

The present invention generally relates to a white light LED. More particularly, the present invention relates to a white light LED for emitting a light comprising at least three or four different colors.

2. Description of Related Art

Light emitting diode (LED) is a semiconductor device being broadly used for light emission. The light emitting chip of the LED is generally comprised of III-V compound semiconductor such as gallium phosphide (GaP), gallium arsenide (GaAs), gallium nitride (GaN). The principle of light emission of LED is the transformation of electrical energy into photon energy, which is performed by applying current to the compound semiconductor to generate electrons and holes. Thereafter, an excess energy is released by the combination of electrons and holes, and thus the LED emits light. The lifetime of an LED is generally up to hundred thousand hours or more. In addition, it is not necessary to warm up the LED when it is turned on, thus the idling time is almost zero. Furthermore, the LED has the advantages of fast response speed (generally about 10⁻⁹ seconds), small size, low power consumption, low contamination (mercury free), high reliability, and the manufacturing process is suitable for mass production. The application of the LED is very broad, and wherein the most widely useful is the white light LED. Especially in recent years, since luminous efficiency of the light emitting diode (LED) has been drastically enhanced, the white light LED may be applied as a light source in many electrical devices, such as, scanner, liquid crystal display (LED), or illumination devices. In recent years, the conventional fluorescent lamp and incandescent bulb is gradually replaced by the white light LED.

In general, a conventional white light LED may be classified into two types listed below. The first one is a white light LED composed by a plurality of monochromatic LED chips, wherein the white light is generated by adjusting the current flowing through each monochromatic LED chip. This type of white light LED may be further classified into white light LED using three wavelengths including red light, blue light and green light LED chips, and white light LED using two wavelengths including yellow light and blue light LED chips. The luminous efficiency of the first type white light LED is high, however, since a plurality of monochromatic LED chips need to be provided simultaneously, the cost is high.

The second one is a white light LED composed by a blue light LED chip and a yellow inorganic fluorescent powder (or yellow organic fluorescence dye). The wavelength of the blue light emitting from the blue light LED chip is generally between 440 nm and 490 nm, and a yellow fluorescence is generated when the yellow inorganic fluorescent powder is illuminated by the blue light. In addition, after the yellow fluorescence is illuminated by the blue light emitting from the blue light LED chip, a white light is generated. The manufacturing process of the second type white light LED is much easier than that of the first type white light LED described above, and the cost is lower. Therefore, the second type white light LED is broadly used. However, it is noted that the luminous efficiency of the second type white light LED is lower than the first type, and the white light of the second type white light LED is generated only by two light (a blue light and yellow light). Therefore, the performance of the color rendering index and the color temperature of the second type white light LED is worse than that of the first type white light LED.

### SUMMARY OF INVENTION

Accordingly, the present invention is directed to a white light LED comprising at least three or four different colors having higher luminous efficiency and better color rendering index.

According to an embodiment of the present invention, the white light LED comprises an exciting light source, a susceptor, a sealing resin and a fluorescent powder. The surface of the susceptor includes a pit, wherein the exciting light source is disposed in the pit of the susceptor and electrically connected to the susceptor. A light having a wavelength in a range of about 250 nm to about 490 nm is emitted from the exciting light source. The sealing resin is disposed over the susceptor and covers over the exciting light source to fix the exciting light source over the susceptor. Furthermore, the fluorescent powder is disposed around the exciting light source to receive the light emitting from the exciting light source. The material of the fluorescent powder includes, for example but not limited to, (Tb_{3-x-y}CeₓRe_{y})Al₅O₁₂, (Me_{1-x-y}EuₓRe_{y})₃SiO₅, YBO₃:Ce³⁺, YBO₃:Tb³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd³⁺.

In one embodiment of the present invention, the above-described white light LED includes, for example but not limited to, a plurality of welding wires electrically connected between the exciting light source and the susceptor. Furthermore, the susceptor includes, for example but not limited to, packaging leadframe or circuit board. The exciting light source includes, for example but not limited to, LED chip or laser diode chip.

In one embodiment of the present invention, the composition of the above-described fluorescent powder is optimized according to the wavelength of the light emitting from the exciting light source. For example, when the wavelength of the light is in a range of about 440 nm to about 490 nm, the fluorescent powder includes, for example but not limited to, (Tb_{3-x-y}CeₓRe_{y})Al₅O₁₂, (Me_{1-x-y}EuₓRe_{y})₃SiO₅, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn or Mg₃SiO₄:Mn. Furthermore, for example, when the wavelength of the light is in a range of about 250 nm to about 440 nm, the fluorescent powder includes, for example but not limited to, (Tb_{3-x-y}CeₓRe_{y})Al₅O₁₂, (Me_{1-x-y}EuₓRe_{y})₃SiO₅, YBO₃:Ce³⁺, YBO₃:TB³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn, Mg₃SiO₄:Mn, BaMgAl₁₀O₁₇:Eu²⁺ or (Ca,Sr,Ba)₅(PO₄)₃Cl:Eu²⁺,GD³⁺.

In one embodiment of the invention, in the above-described fluorescent powder material (Me_{1-x-y}EuₓRe_{y})₃SiO₅ 0<x≦0.8 and 0≦y≦2.0. Furthermore, Me includes, for example but not limited to, calcium, strontium or barium. The Re includes, for example but not limited to, praseodymium (Pr), rubidium, samarium (Sm), dysprosium (Dy), holmium (Ho), yttrium, erbium (Er), europium (Eu), thulium (Tm), ytterbium (Yb), chromium, strontium, lutetium (Lu), gadolinium (Gd), zinc or aluminum.

In one embodiment of the present invention, the white light LED further includes a light emitting diode (LED) chip for emitting a light having wavelength in a range of about 250 nm to about 490 nm. The LED chip may be provided as the exciting light source of the above-described white light LED. The LED chip includes, for example but not limited to, a substrate, a nucleation layer, a conductive buffer layer, a first confinement layer, a light emitting layer, a second confinement layer, a contact layer, an anode electrode and a cathode electrode. The nucleation layer and the conductive buffer layer are disposed over the substrate sequentially. The first confinement layer is disposed over the conductive buffer layer, wherein the type of the doping material of the first confinement layer and that of the conductive buffer layer are the same, and the type of the doping material may be P-type or N-type. The light emitting layer is disposed over the first confinement layer, and the second confinement layer is disposed over the light emitting layer. The type of the doping material of the second confinement layer and that of the first confinement layer are not the same. The contact layer is disposed over the second confinement layer, and the contact layer may includes periodic and modulated doped semiconductor material, including, for example, but not limited to, P-type strained layer superlattice (SLS) structure doped with magnesium, zinc, beryllium, cadmium (Cd), calcium, or carbon or N-type strained layer superlattice (SLS) structure doped with silicon, germanium, antimony, tin, phosphorous, or arsenic. The anode electrode is disposed over the contact layer. The cathode electrode is in contact with the conductive buffer layer and isolated from the first confinement layer, the second confinement layer, the light emitting layer, the contact layer and the anode electrode.

In the above-described LED chip, the conductive type of the second confinement layer and that of the contact layer may be different, wherein the conductive type of the contact layer may be P-type or N-type. Furthermore, the conductive type of the anode electrode and that of the contact layer may also be different, wherein the conductive type of the anode electrode may be P-type or N-type.

Accordingly, in the white light LED according to an embodiment of the present invention, a LED chip (or laser diode chip) for emitting a light having wavelength in a range of about 250 nm to 490 nm is provided as the exciting light source. Moreover, at least a fluorescent powder or a mixture thereof is used to generate, for example but not limited to, yellow, red, green or blue fluorescence. The generated fluorescence such as the yellow, red, green or blue fluorescence is mixed with the exciting light of the exciting light source to generate the white light. The light emitting from the white light LED is composed of mixed light comprising at least three or four different colors, thus the white light LED has a higher luminous efficiency and a better color rendering index.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a drawing schematically illustrating a white light LED according to one embodiment of the present invention.

FIG. 2 is a drawing schematically illustrating a white light LED according to another embodiment of the present invention.

FIG. 3 is a cross-sectional view schematically illustrating a LED chip according to one embodiment of the present invention.

FIG. 4 is a diagram illustrating an emission spectrum of a white light LED according to one embodiment of the present invention.

FIG. 5 is a diagram illustrating an emission spectrum of a white light LED according to another embodiment of the present invention.

FIG. 6 is a diagram illustrating an emission spectrum of a white light LED according to yet another embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

FIG. 1 is a drawing schematically illustrating a white light LED according to one embodiment of the present invention. Referring to FIG. 1, the white light LED 100 comprises, for example but not limited to, a packaging leadframe 110, a LED chip 120 and a sealing resin 130. The packaging leadframe 110 includes, for example but not limited to, a first contact 112a, a second contact 112b and a pit 110a. The LED chip 120 is disposed in the pit 110a by an adhesive glue 140. Furthermore, the LED chip 120 has an anode electrode 122a and a cathode electrode 122b electrically connected to a first contact 112a and a second contact 112b of the packaging leadframe 110 by a welding wire 150 respectively. The sealing resin 130 covers over the LED chip 120 to mount the LED chip 120 in the pit 110a.

Referring to FIG. 1, the LED chip 120 may emit, for example but not limited to, an exciting light 124. The sealing resin 130 is doped with, for example but not limited to, fluorescent powder 132, wherein a portion of the exciting light 124 emits out via the sealing resin 130, and the other portion of the exciting light 124 absorbed by the fluorescent powder 132. The fluorescent materials in the fluorescent powder 132 is excited by the exciting light 124, and thus a fluorescence 134 is generated by the energy transition of the electrons. Therefore, a white light is generated by mixing the exciting light 124 and the fluorescence 134 in the white light LED 100.

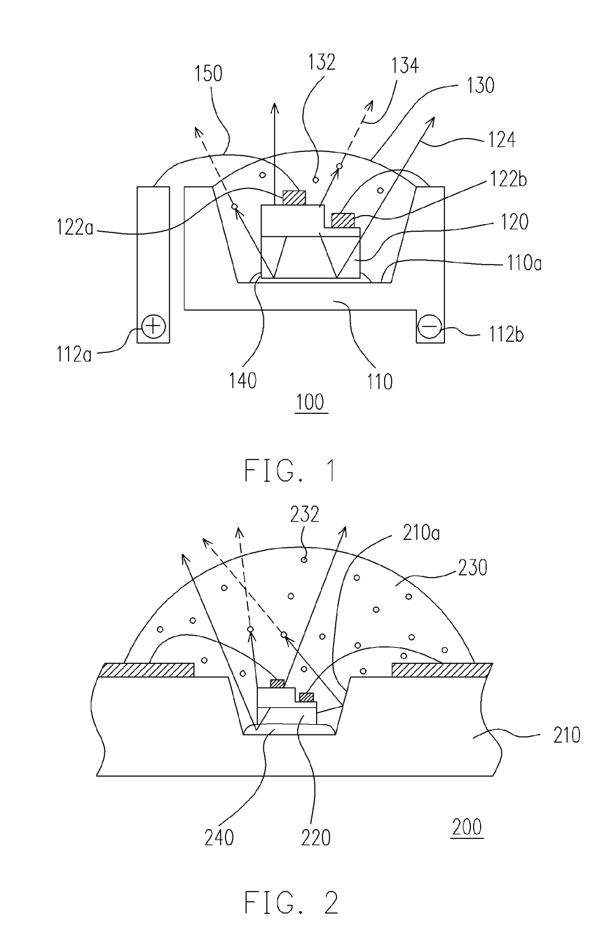

Furthermore, in another embodiment of the present invention, the above-described packaging leadframe of the white light LED may also be replaced by a circuit board. FIG. 2 is a drawing schematically illustrating a white light LED according to another embodiment of the present invention. Referring to FIG. 2, the white light LED 200 comprises, for example but not limited to, a circuit board 210, a LED chip 220 and a sealing resin 230. The LED chip 220 is disposed in a pit 210a on the circuit board 210 via an adhesive glue 240, and is electrically connected to the circuit board 210 by lead bonding. The sealing resin 230 is, for example but not limited to, doped with the fluorescent powder 232 and the sealing resin 230 covers over the LED chip 220. The connection relationship of the elements and the functions thereof of FIG. 2 are similar to that of the embodiments of FIG. 1 described above and thus FIG. 1 may be taken as a reference.

Moreover, in the embodiments of FIGS. 1 and 2, the two electrodes are all disposed on the LED chip on the top.

However, in another embodiment of the present invention, the two electrodes may also be disposed on the LED chips on the top and at the bottom respectively. In addition, the connect method between the LED chip and the packaging leadframe or the circuit board may vary with the position of the electrodes.

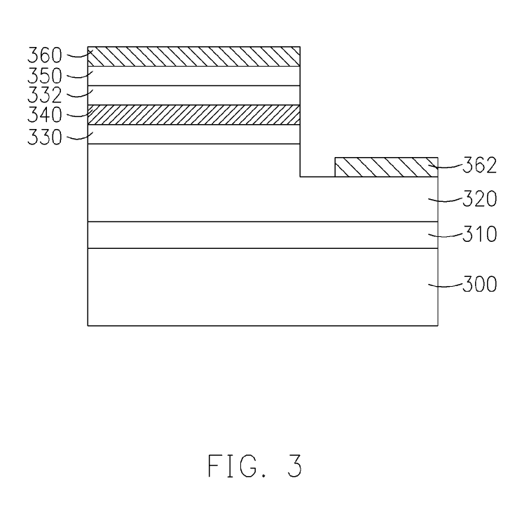

FIG. 3 is a cross-sectional view schematically illustrating a LED chip according to an embodiment of the present invention. Referring to FIG. 3, the light emitting diode (LED) chip comprises a substrate 300. The substrate comprises, for example but not limited to, silicon, sapphire, silcon carbide (SiC), zinc oxide (ZnO), gallium phosphide (GaP), gallium arsenide (GaAs), aluminum oxide (Al₂O₃) substrate or other applicable substrate. Thereafter, a nucleation layer 310 is formed over the substrate 300. The nucleation layer 310 may be comprised of, for example but not limited to, AlᵤInᵥGa₁₋ᵤ₋ᵥN (u,v≧0; 0≦u+v≦1).

The conductive buffer layer 320 may be comprised of, for example but not limited to, Al_{c}In_{d}Ga_{1-c-d}N (c,d≧0; 0≦c+d<1). In general, it is difficult to form a high quality P-type or N-type gallium nitride (GaN) based epitaxial layer on the substrate directly since the lattice mismatch between the P-type or N-type gallium nitride (GaN) based semiconductor and the substrate described above is very large. Therefore, gallium nitride (GaN) based compound semiconductor(s) such as a nucleation layer 310 and buffer layer 320 is previously formed. In the embodiment, the N-type Al_{c}In_{d}Ga_{1-c-d}N is provided as the buffer layer 320 to enhance the quality of the crystals grown in the following gallium nitride (GaN) based compound and the yield of the production.

Thereafter, a first confinement layer 330 is formed on the buffer layer 320, wherein the first confinement layer 330 may be comprised of gallium nitride (GaN) based III-V compound including, for example but not limited to, doped N-type AlₓIn_{y}Ga_{1-x-y}N (x,y≧0; 0≦x+y<1; x>c). The selection of N-type doping material is well known to those skilled in the art and will not be described herein.

Thereafter, an active layer 340 (or called a light emitting layer) is formed over the first confinement layer 330. The active layer 340 may be comprised of gallium nitride (GaN) based III-V nitride compound. In the present embodiment, the active layer 340 may be comprised of doped or undoped A1ₐIn_{b}Ga_{1-a-b}N/A1ₓIn_{y}Ga_{1-x-y}N (a,b≧0; 0≦a+b<1; x,y≧0; 0≦x+y<1; x>c>a) quantum well structure, and the doping material thereof may be N-type or P-type materials. The selection of the N-type or P-type doping material is well known to those skilled in the art and will not be described.

Further, a second confinement layer 332 is formed over the active layer340. The second confinement layer 332 may be comprised of gallium nitride (GaN) based III-V compound including, for example but not limited to, doped P-type A1ₓIn_{y}Ga_{1-x-y}N (x,y≧0; 0≦x+y<1; x>c). The selection of the P-type doped material is well known to those skilled in the art and will not be described herein. The N-type or P-type active layer 340 is sandwiched by the first confinement layer 330 and the second confinement layer 332. The compositions and the ratio thereof of the materials composed in the layers including the gallium nitride (GaN) based III-V compound, and the selection of the doping material thereof described above may be adjusted, and that has been described in the embodiments of the invention may not be used to limit the scope of the invention.

Thereafter, a contact layer 350 is formed over the second confinement layer 332. The contact layer 350 may be comprised of, for example but not limited to, III-V compound having an extremely high carrier concentration such as strained layer superlattice (SLS). The strained layer superlattice (SLS) may be comprised of, for example but not limited to, gallium nitride (GaN) based III-V compound such as A1ᵤInᵥGa₁₋ᵤ₋ᵥN/A1ₓIn_{y}Ga_{1-x-y}N SLS (u,v≧0; 0≦u+v≦1; x,y≧0; 0≦x+y<1; x>u). The strained layer superlattice (SLS) of the embodiment may be a modulation doped SLS, wherein the doping material may be N-type or P-type. In one embodiment of the invention, a P-type doping material is preferred.

Next, a cathode electrode 362 is formed over the buffer layer 320 apart from the first confinement layer 330, the second confinement layer 332 and the active layer340. The cathode electrode 362 may be comprised of, for example but not limited to, Cr/Au, Cr/Pt/Au, Cr/WSiN/Au, WSiₓ/Au, Ti/Siₓ/Au, Ti/Au, Ti/WSiₓ/Au,Ti/Al/Cr/Au, Ti/Al/Co/Au, Cr/Al/Cr/Au, Cr/Al/Pt/Au, Cr/Al/Pd/Au, Cr/Al/Ti/Au, Cr/Al/Co/Au, Cr/Al/Ni/Au, Pd/Al/Ti/Au, Pd/Al/Pt/Au, Pd/Al/Ni/Au, Pd/Al/Pd/Au, Pd/Al/Cr/Au, Pd/Al/Co/Au, Nd/Al/Pt/Au, Nd/Al/Ti/Au, Nd/Al/Ni/Au, Nd/Al/Cr/Au Nd/Al/Co/A, Hf/Al/Ti/Au, Hf/Al/Pt/Au, Hf/Al/Ni/Au, Hf/Al/Pd/Au, Hf/Al/Cr/Au, Hf/Al/Co/Au, Zr/Al/Ti/Au, Zr/Al/Pt/Au, Zr/Al/Ni/Au, Zr/Al/Pd/Au, Zr/Al/Cr/Au, Zr/Al/Co/Au, TiNx/Ti/Au, TiNx/Pt/Au, TiNx/Ni/Au, TiNx/Pd/Au, TiNx/Cr/Au, TiNx/Co/Au TiWNx/Ti/Au, TiWNx/Pt/Au, TiWNx/Ni/Au, TiWNx/Pd/Au, TiWNx/Cr/Au, TiWNx/Co/Au, NiAl/Pt/Au, NiAl/Cr/Au, NiAl/Ni/Au, NiAl/Ti/Au, Ti/NiAl/Pt/Au, Ti/NiAl/Ti/Au, Ti/NiAl/Ni/Au or Ti/NiAl/Cr/Au or other applicable materials. The cathode electrode 362 provides an excellent ohmic contact with the conductive buffer layer, and thus the contact resistance is reduced.

Thereafter, an anode electrode 360 is formed over the contact layer 350. The anode electrode 360 may be comprised of, for example but not limited to, a thin metal comprised of such as Ni/Au, TiN, Pd/Au/Pt/Au, or N-type transparent conductive oxide (TCO) layer such as indium tin oxide (ITO), cadmium tin oxide (CTO), ZnO:Al, ZnO:In, ZnO:Ga, ZnGa₂O₄, SnO₂:Sb, Ga₂O₃:Sn, AginO₂:Sn or In₂O₃:Zn, or P-type TCO such as CuA1O₂, LaCuOS, NiO, Cu-GaO₂ or SrCu₂O₂.

Accordingly, the emitting wavelength of the light emitting diode (LED) chip of the invention is in a range of, for example but not limited to 250 nm to 490 nm. The fluorescent powder includes, for example but not limited to, yellow light fluorescent powder, red light fluorescent powder, green light fluorescent powder, blue light fluorescent powder or a power mixing thereof. The yellow light fluorescent powder may be comprised of, for example but not limited to, (Tb_{3-x-y}CeₓRe_{y})Al₅O₁₂ or (Me_{1-x-y}EuₓRe_{y})₃SiO₅. The red light fluorescent powder may be comprised of, for example but not limited to, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂ O₂S:Bi³⁺, (Me₁₋ₓEuₓ)ReS and 6MgO,As₂O₅:Mn, Mg₃SiO₄:Mn. The green light fluorescent powder may be comprised of, for example but not limited to, YBO₃:Ce³⁺, YBO₃:TB³⁺, SrGa₂O₄:Eu²⁺, SrAl₂O₄:Eu²⁺, (Ba,Sr)MgAl₁₀O₁₇:Eu²⁺ and (Ba,Sr)MgAl₁₀O₁₇:Eu₂,Mn²⁺., The blue light fluorescent powder may be comprised of, for example but not limited to, BaMgAl₁₀O₁₇:Eu²⁺ and (Ca,Sr,Ba)₅(PO₄)₃Cl:Eu²⁺,Gd²⁺. Wherein 0<x≦0.8, and 0≦y≦2.0. The Me comprises calcium, strontium, barium. The Re comprises praseodymium (Pr), rubidium, samarium (Sm), dysprosium (Dy), holmium (Ho), yttrium, erbium (Er), europium (Eu), thulium (Tm), ytterbium (Yb), chromium (Cr), strontium (Sr), lutetium (Lu), gadolinium (Gd), aluminum (Al), or zinc (Zn).

It is noted that the emission spectrum of the white light LED of the present invention is dependent on the wavelength (frequency) of the exciting light and the corresponding fluorescent powder, and will be described by a plurality of embodiments hereinafter.

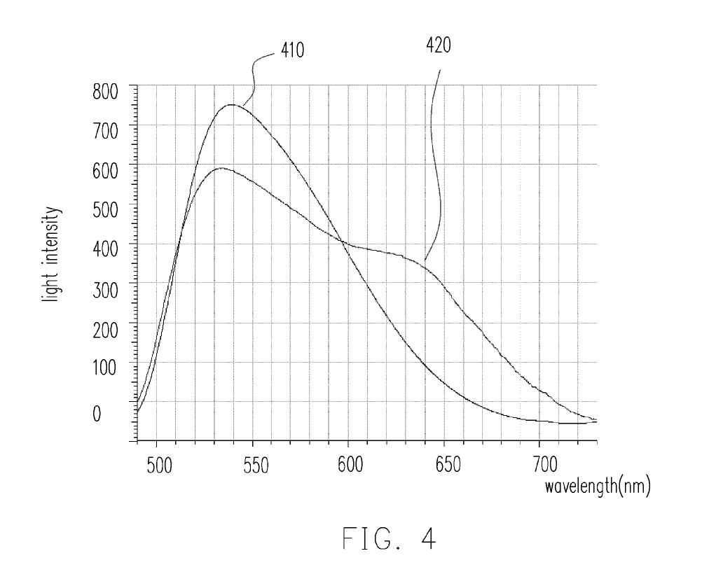

In one embodiment of the invention, the wavelength of the exciting light is, for example, between about 440 nm and about 490 nm. It is noted that, when the LED chip is a blue light LED chip having a wavelength between 440 nm and 490 nm, the fluorescent powder is generally comprised of, for example but not limited to, a fluorescent material having a lower excitation energy state such as yellow light fluorescent powder or red light fluorescent powder. FIG. 4 is a diagram illustrating an emission spectrum of a white light LED according to one embodiment of the present invention. Referring to FIG. 4, the fluorescent powder may be comprised of, for example but not limited to, 92% yellow light fluorescent powder such as Tb₃(Al,Si)₅O₁₂:Gd³⁺,Ce³⁺,Y³⁺,Dy³⁺ and 8% red light fluorescent powder such as (Sr,Ca)ReS:Eu²⁺. Therefore, the wavelength of the blue exciting light of the LED chip is near about 470 nm. The wavelength of the yellow fluorescence 410 generated by the yellow light fluorescent powder is between about 540 nm to about 580 nm. The peak value of the wavelength of the red fluorescence 420 generated by the red light fluorescent powder is near about 610 nm. Thereafter, a white light is generated by mixing the blue exciting light, the yellow fluorescence and the red fluorescence, and the white light has a high color rendering index since it is generated by three color lights. Thus, the white light LED of the present invention provides the advantages of the second type white light LED.

In the above-described embodiment, the emission spectrum of the white light LED may be tuned by fixing the type of the fluorescent powder and adjusting the composition of each component material. For example, if the fluorescent powder is comprised of 20% yellow light fluorescent powder such as Tb₃(Al,Si)5O₁₂:Gd³⁺,Ce³⁺,Y³⁺,Dy³⁺ and 80% red light fluorescent powder such as (Sr,Ca)ReS:Eu²⁺, the wavelength of the blue exciting light of the LED chip is about 450 nm. Therefore, after the exciting light is emitted, the light intensity of the red fluorescence emitting from the red light fluorescent powder is higher than that of the yellow fluorescence emitting from the yellow light fluorescent powder. Therefore, a high intensity pink light is generated after the mixing of lights.

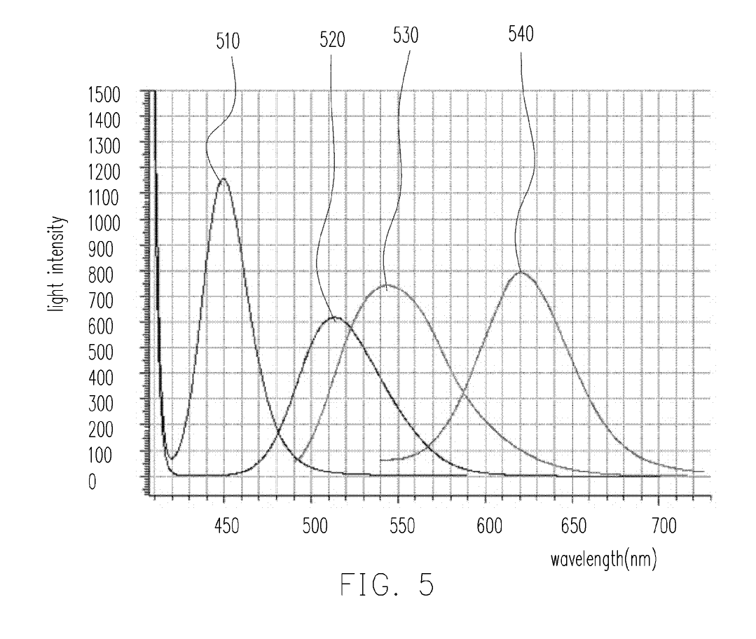

In another embodiment of the invention, the wavelength of the exciting light is, for example, between about 395 nm and about 440 nm. FIG. 5 is a diagram illustrating an emission spectrum of a white light LED according to another embodiment of the present invention. Referring to FIG. 5, the fluorescent powder is comprised of, for example but not limited to, yellow light fluorescent powder such as Tb₃Al₅O₁₂:Gd³⁺, Ce³⁺,Y³⁺, Sr₃SiO₅:Eu²⁺, green light fluorescent powder such as SrAl₂O₄:Eu²⁺, (Ba,Sr)_{2.5}SiO₅:Eu²⁺, red fluorescent powder such as (Sr,Ca)ReS:Eu²⁺, Mg₃SiO₄:Mn and blue light fluorescent powder such as (Ca,Sr,Ba)₅(PO₄)₃Cl:Eu²⁺,Gd²⁺. Thereafter, a blue violet light having a wavelength of about 405 nm is provided as the exciting light. After the exciting light is absorbed by the blue light fluorescent powder, a blue fluorescence 510 having a wavelength of about 460 nm is emitted. Likewise, a green fluorescence 520 having a wavelength about 520 nm is emitted from the green light fluorescent powder after the exciting light is absorbed. A red fluorescence 540 having a wavelength about 610 nm is emitted from the red light fluorescent powder after the exciting light is absorbed. Furthermore, a yellow fluorescence 530 emitting from the yellow light fluorescent powder by absorbing a portion of the blue fluorescence emitting from the blue light fluorescent powder. Therefore, a white light is generated by mixing the red fluorescence, the blue fluorescence, the green fluorescence and the yellow fluorescence generated by the blue violet exciting light. The white light has an excellent color rendering index since it is generated by at least four different colors.

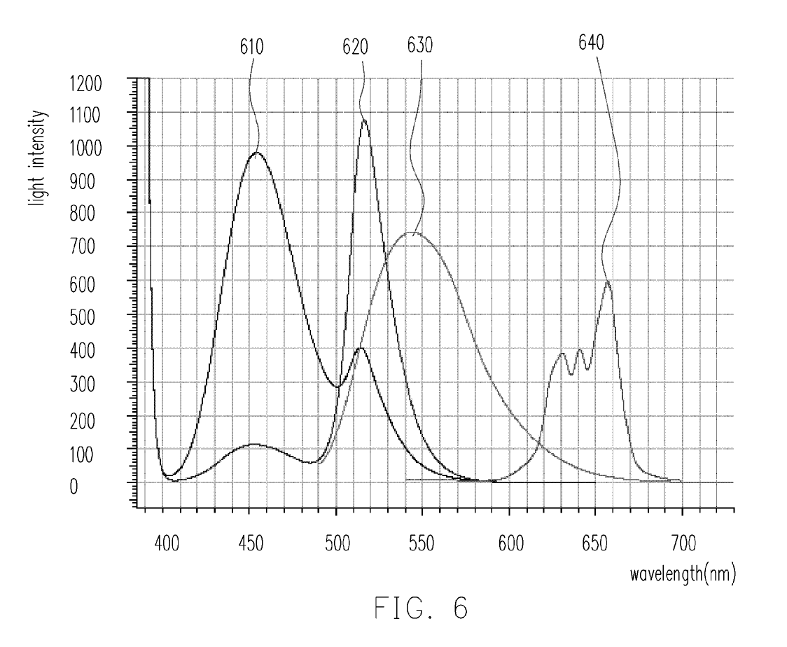

In another one embodiment of the invention, the wavelength of the exciting light is, for example, between about 250 nm and 395 nm. FIG. 6 is a diagram illustrating an emission spectrum of a white light LED according to yet another embodiment of the present invention. Referring to FIG. 6, the fluorescent powder is comprised of yellow light fluorescent powder such as Tb₃Al₅O₁₂:Gd³⁺, Ce³⁺,Y³⁺, Sr₃SiO₅:Eu²⁺, green light fluorescent powder such as (Ba,Sr)_{2.5}SiO₅:Eu²⁺, (Ba,Sr)MgAl₁₀O₁₇:Eu²⁺, or (Ba,Sr)MgAl₁₀O₁₇:Mn²⁺, red fluorescent powder such as (Sr,Ca)ReS:Eu²⁺, Mg₃SiO₄:Mn, 6MgO.As₂O₅:Mn²⁺ and blue light fluorescent powder such as (Ca,Sr,Ba)₅(PO4)₃Cl:Eu²⁺,Gd³⁺. A violet light of wavelength about 385 nm is provided as the exciting light. Therefore, after the excitation of the exciting light, green fluorescence 620 of wavelength about 510 nm is emitted from the green light fluorescent powder, a blue fluorescence 610 of wavelength about 450 nm is emitted fromthe blue light fluorescent powder, a red fluorescence 640 of wavelength about 660 nm is emitted from the red light fluorescent powder. And a yellow fluorescence 630 is emitted from the yellow light fluorescent powder after a portion of the blue fluorescence emitting from the blue light fluorescent powder is absorbed. Therefore, a white light is generated by mixing at least four different color lights and has an excellent color rendering index.

According to the above-described embodiments of the present invention, a high energy exciting light such as a violet exciting light having a wavelength between about 365 nm and about 395 nm, or an ultraviolet exciting light having a wavelength less than 365 nm is provided to the white light LED. In addition, the fluorescent powder of the invention is further comprised of high excitation energy state material such as green light fluorescent powder or blue light fluorescent powder except for comprised of conventional red light fluorescent powder or yellow light fluorescent powder. Moreover, the shorter the wavelength of the exciting light emitting from the LED chip of the present invention, the higher the energy of the exciting light, and thus the more the fluorescent powder that can be reacted with the exciting light, and the higher the percentage of the excited fluorescent powder will emit fluorescence with brightness proportional to the percentage of the excited fluorescent powder.

Accordingly, the present invention provides an exciting light source having a wavelength between about 250 nm and 490 nm to excite the fluorescent powder to generate the exciting light. Therefore, the excited fluorescent powder is dependent on the wavelength (frequency) of the exciting light source. The present invention provides a white light LED mixed by three, four or more different color lights, however, the conventional white light LED is only mixed by two different color lights. Therefore, the luminous efficiency and the color rendering index of the white light LED are better than that of the conventional one. Furthermore, in comparison with the conventional white light LED constructed by a plurality of LED chips, the white light LED of the present invention is low cost, can be produced using a simple process with higher throughput.

Furthermore, it is noted that, the exciting light source of the white light LED of the present invention may further comprise laser diode or other exciting light source except for the LED chips of the above-described embodiments. In addition, the composition of the fluorescent powder of the present invention may be adjusted with the property such as color, brightness, etc. of the required emitted white light and the wavelength or other properties of the exciting light source. In the invention, a LED having a specified color or brightness or, or a full-color LED may also be provided by adjusting the composition of the fluorescent powders.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A white light light emitting diode (LED), comprising:
an exciting light source, for emitting a light, wherein a wavelength of the light is in a range of about 250 nm to about 490 nm; and
a fluorescent powder, disposed around the exciting light source, for absorbing the light emitting from the exciting light source, wherein a material of the fluorescent powder is selected from a group consisting of (Tb_{3-x-y}CeₓRe_{y})Al₅O₁₂, (Me_{1-x-y}EuₓRe_{y})₃SiO₅, YBO₃:Ce³⁺, YBO₃:Tb³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺,(Me₁₋ₓEuₓ)ReS, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd²⁺.

2. The white light LED of claim 1, wherein when the wavelength of the light is in a range of about 440 nm to about 490 nm, the material of the fluorescent powder is selected from a group consisting of (Tb_{3-x-y}CeₓRe_{y})Al₅O₁₂, (Me_{1-x-y}EuₓRe_{y})₃SiO₅, Y₂O₃:Bi^{3+,} (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn and Mg₃SiO₄:Mn.

3. The white light LED of claim 1, wherein when the wavelength of the light is in a range of about 250 nm to about 440 nm, the material of the fluorescent powder is selected from a group consisting of (Tb_{3-x-y}CeₓRe_{y})Al₅O₁₂, (Me_{1-x-y}EuₓRe_{y})₃SiO₅, YBO₃:Ce³⁺, YBO₃:TB³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³, (Y,Gd)₂O₃:Bi³⁺, Y₂O₂S:Eu³⁺, Y₂O₂S:Bi³⁺,(Me₁₋ₓEuₓ)ReS, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd²⁺.

4. The white light LED of claim 1, wherein 0<x≦0.8 and 0≦y≦2.0.

5. The white light LED of claim 1, wherein Me comprises calcium, strontium, or barium.

6. The white light LED of claim 1, wherein Re comprises praseodymium (Pr), rubidium, samarium (Sm), dysprosium (Dy), holmium (Ho), yttrium, erbium (Er), europium (Eu), thulium (Tm), ytterbium (Yb), chromium, strontium, lutetium (Lu), gadolinium (Gd), aluminum, or zinc.

7. The white light LED of claim 1, wherein the exciting light source comprises LED chip or laser diode chip.

8. A white light light emitting diode (LED), comprising:
a susceptor, having a pit in a surface of the susceptor;
an exciting light source, disposed in the pit of the susceptor and electrically connected to the susceptor, wherein a light having a wavelength in a range of about 250 nm to about 490 nm is emitted from the exciting light source;
a sealing resin, disposed over the susceptor, wherein the exciting light source is covered by the sealing resin to mount the exciting light source over the susceptor; and
a fluorescent powder, disposed in the sealing resin, and for receiving the light emitting from the exciting light source, wherein a material of the fluorescent powder is selected from a group consisting of (Tb_{3-x-y}CeₓRe_{y})Al₅O1₂, (Me_{1-x-y}EuₓRe_{y})₃SiO₅, YBO₃:Ce³⁺, YBO₃:TB³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd²⁺.

9. The white light LED of claim 8, further comprising:
a plurality of welding wire, electrically connected between the exciting light source and the susceptor.

10. The white light LED of claim 8, wherein the susceptor comprises a packaging leadframe or a circuit board.

11. The white light LED of claim 8, wherein the exciting light source comprises a LED chip or a laser diode chip.

12. The white light LED of claim 8, wherein when the wavelength of the light is in a range of about 440 nm to about 490 nm, the material of the fluorescent powder is selected from a group consisting of (Tb_{3-x-y}CeₓRe_{y})Al₅O1₂, (Me_{1-x-y}EuₓRe_{y})₃SiO₅, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn, and Mg₃SiO₄:Mn.

13. The white light LED of claim 8, wherein when the wavelength of the light is in a range of about 250 nm to about 440 nm, the material of the fluorescent powder is selected from a group consisting of (Tb_{3-x-y}CeₓRe_{y})Al₅O1₂, (Me_{1-x-y}EuₓRe_{y})₃SiO₅, YBO₃:Ce³⁺, YBO₃:TB³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)Res, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd²⁺.

14. The white light LED of claim 8, wherein 0<x≦0.8, and 0≦y≦2.0.

15. The white light LED of claim 8, wherein Me comprises calcium, strontium, or barium.

16. The white light LED of claim 8, wherein Re comprises praseodymium (Pr), rubidium, samarium (Sm), dysprosium (Dy), holmium (Ho), yttrium, erbium (Er), europium (Eu), thulium (Tm), ytterbium (Yb), chromium, strontium, lutetium (Lu), gadolinium (Gd), aluminum, or zinc.

17. A white light light emitting diode (LED), at least comprising:
a LED chip, for emitting a light having a wavelength in a range of about 250 nm to about 490 nm, wherein the LED chip comprising:
a substrate;
an nucleation layer, disposed over the substrate;
a conductive buffer layer, disposed over the nucleation layer;
a first confinement layer, disposed over the conductive buffer layer, wherein a type of a (conductive) doping material of the first confinement layer and a type of a (conductive) doping material of the conductive buffer layer are the same;
a light emitting layer, disposed over the first confinement layer, wherein the light emitting layer comprises doped III-V compound semiconductor material;
a second confinement layer, disposed over the light emitting layer, wherein a type of the (conductive) doping material of the second confinement layer and the type of the (conductive) doping material of the first confinement layer are different;
a contact layer, disposed over the second confinement layer, wherein the contact layer comprises a superlattice structure material layer;
an anode electrode, disposed over the contact layer;
a cathode electrode, contacted to the conductive buffer layer, and isolated from the first and the second confinement layer, the light emitting layer, the contact layer and the anode electrode; and
a fluorescent powder, disposed around the exciting light source, and for receiving the light emitting from the exciting light source, wherein a material of the fluorescent powder is selected from a group consisting of (Tb_{3-x-y}CeₓRe_{y})Al₅O₁₂, (Me_{1-x-y}EuₓRe_{y})₃SiO₅, YBO₃:Ce³⁺, YBO₃:TB³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd²⁺.

18. The white light LED of claim 17, wherein when a wavelength of the light is in a range of about 440 nm to about 490 nm, the material of the fluorescent powder is selected from a group consisting of (Tb_{3-x-y}CeₓRe_{y})Al₅O₁₂, (Me_{1-x-y}EuₓRe_{y})₃SiO₅, Y₂O₃:Eu³⁺, Y₂O₃:Bi³⁺, (Y,Gd)₂O:Eu³⁺, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn and Mg₃SiO₄:Mn.

19. The white light LED of claim 17, wherein when the wavelength of the light is in a range of about 250 nm to about 440 nm, the material of the fluorescent powder is selected from a group consisting of (Tb_{3-x-y}CeₓRe_{y})Al₅O₁₂,(Me_{1-x-y}EuₓRe_{y})₃SiO₅, YBO₃:Ce³⁺, YBO₃:TB³⁺, SrGa₂O₄:Eu²⁺, SrAl₂O₄:Eu²⁺, (Ba,Sr)MgAl₁₀O₁₇:Eu²⁺, (Ba,Sr)MgAl₁₀O₁₇:Mn²⁺, Y₂O₃:Eu³⁺, Y₂O₃:Bi³⁺, (Y,Gd)₂O₃:Eu³, (Y,Gd)₂O₃:Bi³⁺, Y₂O₂S:Eu³⁺, Y₂O₂S:Bi³⁺, (Me₁₋ₓEuₓ)ReS, 6MgO,As₂O₅:Mn, Mg₃SiO₄:Mn, BaMgAl₁₀O₁₇:Eu²⁺ and (Ca,Sr,Ba)₅(PO₄)₃Cl:Eu²⁺,Gd²⁺.

20. The white light LED of claim 17, wherein 0<x≦0.8 and 0≦y≦2.0.

21. The white light LED of claim 17, wherein Me comprises calcium, strontium or barium.

22. The white light LED of claim 17, wherein Re comprises praseodymium (Pr), rubidium, samarium (Sm), dysprosium (Dy), holmium (Ho), yttrium, erbium (Er), europium (Eu), thulium (Tm), ytterbium (Yb), chromium, strontium, lutetium (Lu), gadolinium (Gd), aluminum or zinc.

23. The white light LED of claim 17, wherein a super high conductivity material of the contact layer comprises strained layer superlattice (SLS) material.

24. The white light LED of claim 23, wherein a conductive type of the contact layer and a conductive type of the second confinement layer are different.

25. The white light LED of claim 23, wherein a conductive type of the contact layer and a conductive type of the anode electrode are different.

26. The white light LED of claim 17, wherein the anode electrode comprises a conventional metal used in a semiconductor process and a multi-layer structure composed of a mixture of the conventional metal, wherein a total thickness of the anode electrode is equal to or less than 0.1 μm.

27. The white light LED of claim 26, wherein the anode electrode comprises a transparent conductive oxide (TCO), wherein the TCO comprises a N-type conductive material comprising indium tin oxide (ITO), cadmium tin oxide (CTO), ZnO:Al, ZnO:In, ZnO:Ga, ZnGa₂O₄, SnO₂:Sb, Ga₂O₃:Sn, AgInO₂:Sn and In₂O₃:Zn, or a P-type conductive material comprising CuAlO₂, LaCuOS, NiO, CuGaO₂ and SrCu₂O₂.

28. The white light LED of claim 17, wherein the substrate is comprised aluminum oxide, sapphire, silcon carbide (SiC), zinc oxide (ZnO), silicon substrate, gallium phosphide (GaP) or gallium arsenide (GaAs).

29. The white light LED of claim 17, wherein the light emitting layer comprises a doped III-V compound semiconductor quantum well structure.

30. The white light LED of claim 29, wherein the quantum well structure comprises doped III-V compound semiconductor comprising AlₐIn_{b}Ga_{1-a-b}N/AlₓIn_{y}Ga_{1-x-y}N, wherein a,b≧0; 0≦a+b<1; x,y≧0; 0≦x+y<1; x>c>a.

31. The white light LED of claim 17, wherein the cathode electrode comprises Cr/Au, Cr/Pt/Au, Cr/WSiN/Au, WSiₓ/Au, Ti/Siₓ/Au, Ti/Au, Ti/WSiₓ/Au, Ti/Al/Cr/Au, Ti/Al/Co/Au, Cr/Al/Cr/Au, Cr/Al/Pt/Au, Cr/Al/Pd/Au, Cr/Al/Ti/Au, Cr/Al/Co/Au, Cr/Al/Ni/Au, Pd/Al/Ti/Au, Pd/Al/Pt/Au, Pd/Al/Ni/Au, Pd/Al/Pd/Au, Pd/Al/Cr/Au, Pd/Al/Co/Au, Nd/Al/Pt/Au, Nd/Al/Ti/Au, Nd/Al/Ni/Au, Nd/Al/Cr/Au Nd/Al/Co/A, Hf/Al/Ti/Au, Hf/Al/Pt/Au, Hf/Al/Ni/Au, Hf/Al/Pd/Au, Hf/Al/Cr/Au, Hf/Al/Co/Au, Zr/Al/Ti/Au, Zr/Al/Pt/Au, Zr/Al/Ni/Au, Zr/Al/Pd/Au, Zr/Al/Cr/Au, Zr/Al/Co/Au, TiNx/Ti/Au, TiNx/Pt/Au, TiNx/Ni/Au, TiNx/Pd/Au, TiNx/Cr/Au, TiNx/Co/Au TiWNx/Ti/Au, TiWNx/Pt/Au, TiWNx/Ni/Au, TiWNx/Pd/Au, Ti-WNx/Cr/Au, TiWNx/Co/Au, NiAl/Pt/Au, NiAl/Cr/Au, NiAl/Ni/Au, NiAl/Ti/Au, Ti/NiAl/Pt/Au, Ti/NiAl/Ti/Au, Ti/NiAl/Ni/Au or Ti/NiAl/Cr/Au.
